(19) United States
(12) Patent Application Publication
(10) Pub. No.: US 2004/0150624 A1
(43) Pub. Date: Aug. 5, 2004

(54) Mouse pointing device structure

(76) Inventor: Chun-Chung Huang, Taipei (TW)

Correspondence Address: QUINTERO LAW OFFICE, 1617 BROADWAY, 3RD FLOOR, SANTA MONICA, CA, 90404, US

(21) Appl. No.: 10/730,407

(22) Filed: Dec. 8, 2003

(30) Foreign Application Priority Data
Jan. 30, 2003 (TW) 92201905

(51) Int. Cl. G09G 5/08

(52) U.S. Cl. 345/166

(57) ABSTRACT

A mouse pointing device structure. The mouse pointing device structure includes a main body, a cover, a button device and an irradiation device. The cover is disposed on the main body and has a transparent portion. The button device is disposed on the cover. The transparent portion is located between the main body and button device. The irradiation device is disposed between the cover and main body. The light output from the irradiation device is output to the outside of the mouse pointing device structure through the transparent portion.

### BACKGROUND OF THE INVENTION

1. Field of the Invention

The present invention relates to a mouse pointing device structure, and in particular to a mouse pointing device structure that generates uniform radiation.

2. Description of the Related Art

Generally speaking, mouse pointing devices usually employ radiation effects to present an aesthetically pleasing appearance. For example, a LED is disposed in the roller structure of a mouse to produce radiation effects on the roller thereof. Nevertheless, the LED is a point light source having uneven brightness distribution, and thus adversely affects the appearance of the mouse.

Hence, there is a need to provide a mouse pointing device structure that generates uniform radiation. The light output from the interior of the mouse pointing device structure is guided and scattered to the outside thereof, such that the mouse pointing device structure has uniform radiation.

### SUMMARY OF THE INVENTION

Accordingly, an object of the invention is to provide a mouse pointing device structure. The mouse pointing device structure comprises a main body, a cover, a button device and an irradiation device. The cover is disposed on the main body and has a transparent portion. The button device is disposed on the cover. The transparent portion is located between the main body and button device. The irradiation device is disposed between the cover and main body. The light output from the irradiation device is output to the outside of the mouse pointing device structure through the transparent portion.

Preferably, the transparent portion is annular and embraces the main body and button device.

Preferably, the irradiation device further comprises an optical fiber and a first light-emitting element. The outer surface of the optical fiber is formed with a plurality of notches to scatter the light therein out.

Preferably, the bottom of the cover further comprises an annular groove. The optical fiber is disposed in the annular groove. The first light-emitting element is disposed on one end of the optical fiber to output light into the optical fiber.

Preferably, the annular groove corresponds to the transparent portion.

Preferably, the first light-emitting element is a light-emitting diode (LED) or an electroluminescence lamp (EL).

Preferably, the irradiation device further comprises at least one second light-emitting element. The light output from the second light-emitting element is transmitted to the outside of the mouse pointing device structure through the transparent portion directly or by reflection of the button device.

Preferably, the mouse pointing device structure further comprises an optical module. The second light-emitting element is disposed on the optical module.

Preferably, the bottom of the cover further comprises at least one hollow light-guiding cylinder. The second light-emitting element is disposed in the hollow light-guiding cylinder.

Preferably, the second light-emitting element is disposed on the main body.

Preferably, the second light-emitting element is a light-emitting diode (LED) or an electroluminescence lamp (EL).

Preferably, the cover is made of acrylic or transparent plastic.

Preferably, the button device is made of a reflective material.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective assembled view of the mouse pointing device structure of the invention;

FIG. 2 is a partial perspective exploded view of the first embodiment of the invention;

FIG. 3 shows the bottom of the cover according to FIG. 2;

FIG. 4 is a perspective exploded view of the second embodiment of the invention;

FIG. 5 is another perspective exploded view of the second embodiment of the invention; and

FIG. 6 is a schematic view showing the light reflected and transmitted between the cover and button device.

### DETAILED DESCRIPTION OF THE INVENTION

First Embodiment

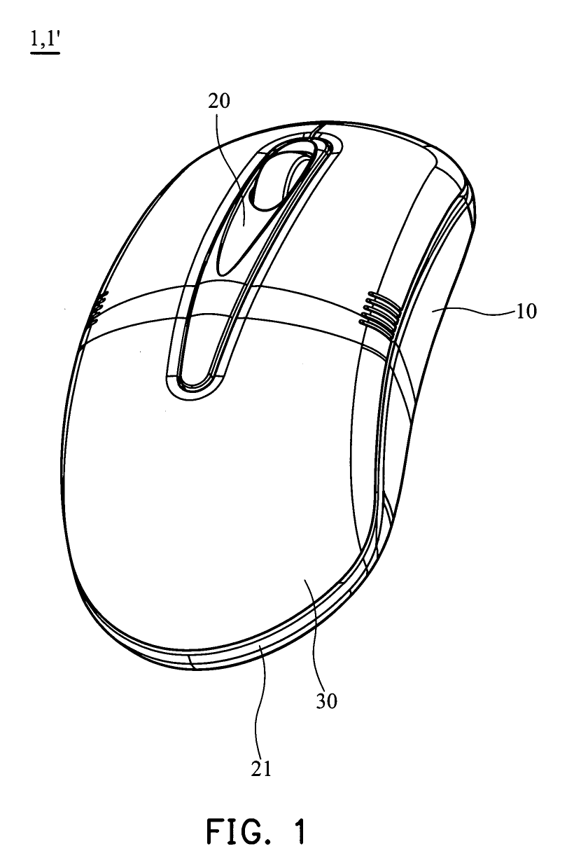

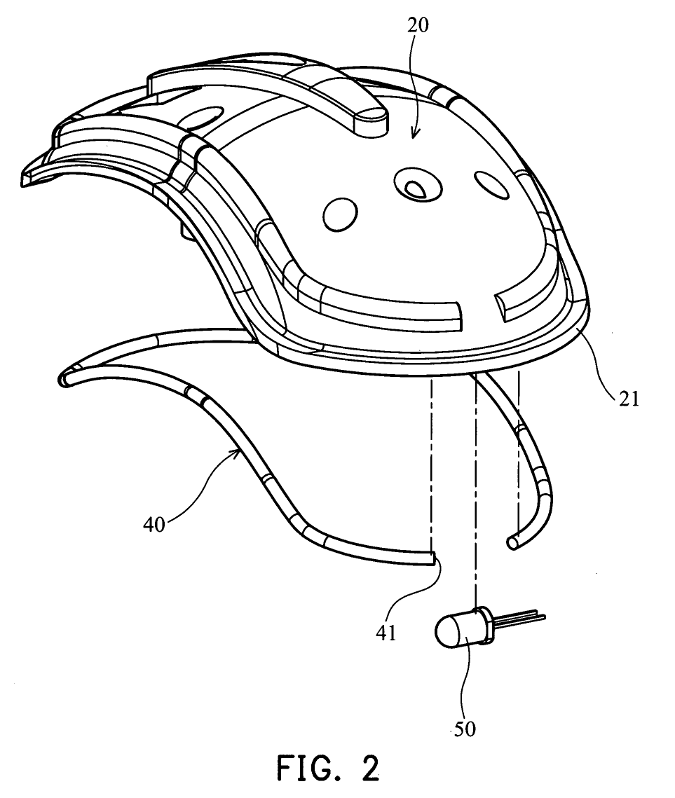

Referring to FIG. 1 and FIG. 2, the mouse pointing device structure 1 comprises a main body 10, a cover 20 and a button device 30. The cover 20 is disposed on the main body 10. The button device 30 is disposed on the cover 20. Meanwhile, the cover 20 has an annular transparent portion 21 located between the main body 10 and button device 30. When the main body 10, cover 20 and button device 30 are assembled, the annular transparent portion 21 embraces the main body 10 and button device 30.

As shown in FIG. 2, the cover 20 is made of a material having excellent transparency, such as acrylic or transparent plastic. The button device 30 is made of an opaque or reflective material.

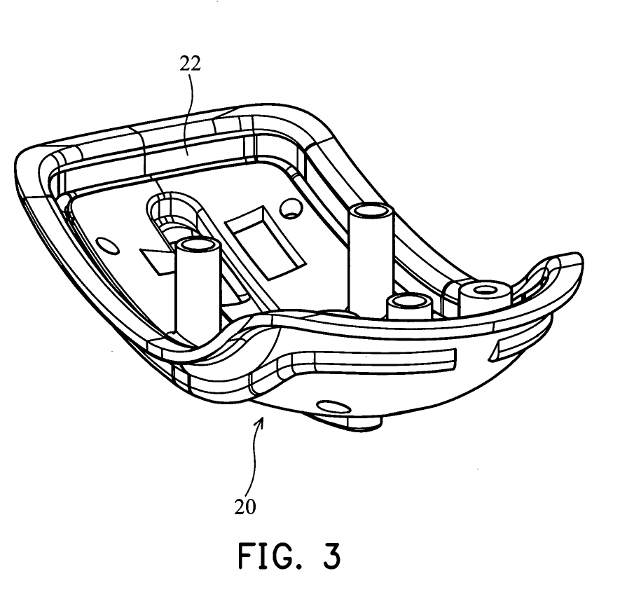

As shown in FIG. 2 and FIG. 3, the mouse pointing device structure 1 further comprises an optical fiber 40 and a first light-emitting element 50. Additionally, the bottom of the cover 20 is formed with an annular groove 22. The optical fiber 40 is disposed in the annular groove 22. Specifically, the annular groove 22 corresponds to the annular transparent portion 21. Meanwhile, the first light-emitting element 50 is connected to one end 41 of the optical fiber 40 to output light into the optical fiber 40.

In this embodiment, the first light-emitting element 50 may be a light-emitting diode (LED) or electroluminescence lamp (EL) . Specifically, the first light-emitting element 50 is not limited to being connected to the end 41 of the optical fiber 40. Namely, the first light-emitting element 50 may be connected to any part of the optical fiber 40 as long as the light output from the first light-emitting element 50 can be transmitted into the optical fiber 40.

Moreover, the outer surface of the optical fiber 40 is formed with a plurality of notches (not shown) to scatter the light therein out.

Accordingly, when the first light-emitting element 50 outputs light, the light passes through the entire optical fiber 40 and is scattered out of the optical fiber 40. Since the optical fiber 40 is disposed in the annular groove 22 and the annular groove 22 corresponds to the annular transparent portion 21, the light from the optical fiber 40 is transmitted to the outside of the mouse pointing device structure 1 through the annular transparent portion 21 to thereby have a uniform radiation effect.

Furthermore, the first light-emitting element 50 may be a discoloring light-emitting element, such that the radiation of the mouse pointing device structure 1 is versatile.

Second Embodiment

Elements corresponding to those in the first embodiment are given the same reference numerals, and explanation thereof will be omitted for simplification of the description.

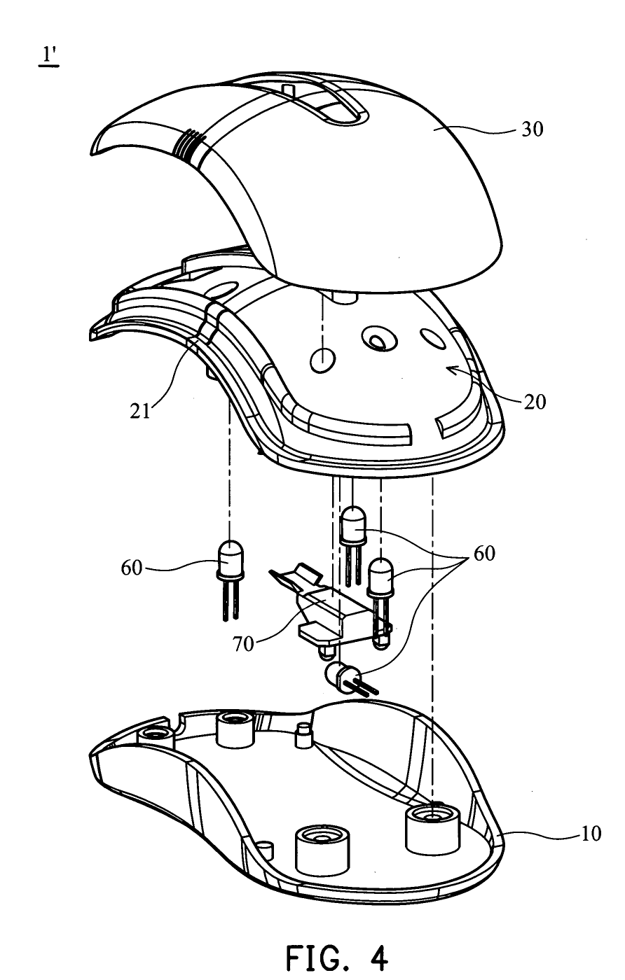

Referring to FIG. 1 and FIG. 4, the cover 20 is made of a material having excellent transparency, such as acrylic or transparent plastic. The button device 30 is made of a material having high reflectivity.

As shown in FIG. 4, the mouse pointing device structure 1′ has at least one second light-emitting element 60 disposed on the main body 10.

Specifically, when the mouse pointing device structure 1′ has an optical module 70, the LED or other light-emitting element on the optical module 70 can serve as the second light-emitting element 60.

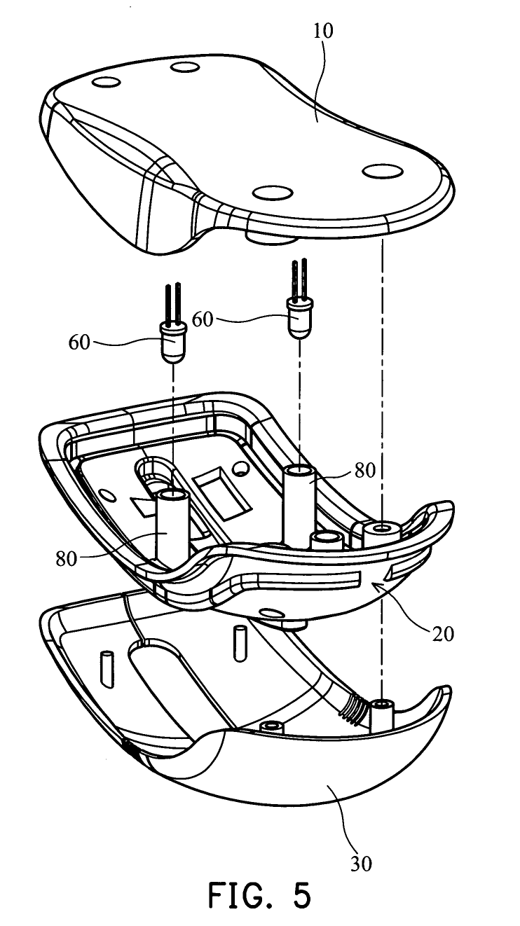

Additionally, as shown in FIG. 5, two hollow light-guiding cylinders 80 are formed on the bottom of the cover 20. Two second light-emitting elements 60 are disposed in the hollow light-guiding cylinders 80, respectively. Specifically, the hollow light-guiding cylinders 80 are transparent.

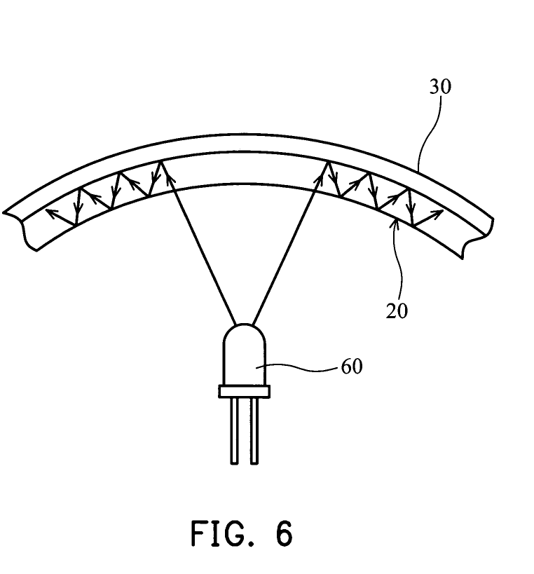

Accordingly, since the cover 20 is made of a material having excellent transparency and the button device 30 is made of a material having high reflectivity, the light output from the second light-emitting element 60 is reflected and transmitted between the cover 20 and button device 30, as shown in FIG. 6. Then, the light is transmitted to the outside of the mouse pointing device structure 1′ through the annular transparent portion 21.

Also, the light output from the second light-emitting element 60 can be transmitted to the outside of the mouse pointing device structure 1′ through the annular transparent portion 21 directly to thereby have a uniform radiation effect.

Similarly, the second light-emitting element 60 may be a discoloring light-emitting element, such that the radiation of the mouse pointing device structure 1′ is versatile.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

what is claimed is:

1. A mouse pointing device structure, comprising:
a main body;
a cover disposed on the main body and having a transparent portion;
a button device disposed on the cover, wherein the transparent portion is located between the main body and button device; and
an irradiation device disposed between the cover and main body, wherein the light output from the irradiation device is output to the outside of the mouse pointing device structure through the transparent portion.

2. The mouse pointing device structure as claimed in claim 1, wherein the transparent portion is annular and embraces the main body and button device.

3. The mouse pointing device structure as claimed in claim 1, wherein the irradiation device further comprises an optical fiber and a first light-emitting element, the outer surface of the optical fiber formed with a plurality of notches to scatter the light therein out.

4. The mouse pointing device structure as claimed in claim 3, wherein the bottom of the cover further comprises an annular groove, the optical fiber disposed in the annular groove, and the first light-emitting element disposed on one end of the optical fiber to output light into the optical fiber.

5. The mouse pointing device structure as claimed in claim 4, wherein the annular groove corresponds to the transparent portion.

6. The mouse pointing device structure as claimed in claim 3, wherein the first light-emitting element is a light-emitting diode.

7. The mouse pointing device structure as claimed in claim 3, wherein the first light-emitting element is an electroluminescence lamp (EL).

8. The mouse pointing device structure as claimed in claim 1, wherein the irradiation device further comprises at least one second light-emitting element, the light output from the second light-emitting element transmitted to the outside of the mouse pointing device structure through the transparent portion directly or by reflection of the button device.

9. The mouse pointing device structure as claimed in claim 8, further comprising an optical module, the second light-emitting element disposed on the optical module.

10. The mouse pointing device structure as claimed in claim 8, wherein the bottom of the cover further comprises at least one hollow light-guiding cylinder, the second light-emitting element disposed in the hollow light-guiding cylinder.

11. The mouse pointing device structure as claimed in claim 8, wherein the second light-emitting element is disposed on the main body.

12. The mouse pointing device structure as claimed in claim 8, wherein the second light-emitting element is a light-emitting diode.

13. The mouse pointing device structure as claimed in claim 8, wherein the second light-emitting element is an electroluminescence lamp (EL).

14. The mouse pointing device structure as claimed in claim 1, wherein the cover is made of acrylic or transparent plastic.

15. The mouse pointing device structure as claimed in claim 1, wherein the button device is made of a reflective material.
